(19) United States
(12) Patent Application Publication
(10) Pub. No.: US 2004/0008520 A1
(43) Pub. Date: Jan. 15, 2004

(54) Mobile illumination system for a golf course

(76) Inventor: Yao-Hung Huang, Yung Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/191,523

(22) Filed: Jul. 10, 2002

(51) Int. Cl. B60Q 1/06; F21V 14/02

(52) U.S. Cl. 362/524; 362/525; 362/526; 362/37

(57) ABSTRACT

A mobile illumination system for a golf course comprises a vehicle and a lamp set, the vehicle can move around while the lamp set illuminates the golf course at night time, the lamp set is composed of at least two spot lights and is able to adjust its angle individually for golfers to strike ball and to aim destination.

### FIELD OF THE INVENTION

This invention relates to a golf course lighting system, and more particularly, to a mobile lighting system.

### BACKGROUND OF THE INVENTION

Most of the golf courses today are equipped with spot light systems for golfers to play at night. This system consumes a lot of electric power and increases the cost. There is still dead spot to golfers even with the spot lights.

### SUMMARY OF THE INVENTION

It is the primary object of the present invention to provide a mobile illumination system for a golf course, which can light any place even a dead spot.

It is another object of the present invention to provide a mobile illumination system for a golf course, which consumes less electric power and is cost effectiveness.

It is a further object of the present invention to provide a mobile illumination system for a golf course, which lights are adjustable and may be operated separately.

### BRIEF DESCRIPTION OF THE DRAWINGS

FIG. 1 is a side view of a golf car incorporated with the illumination system of the present invention;

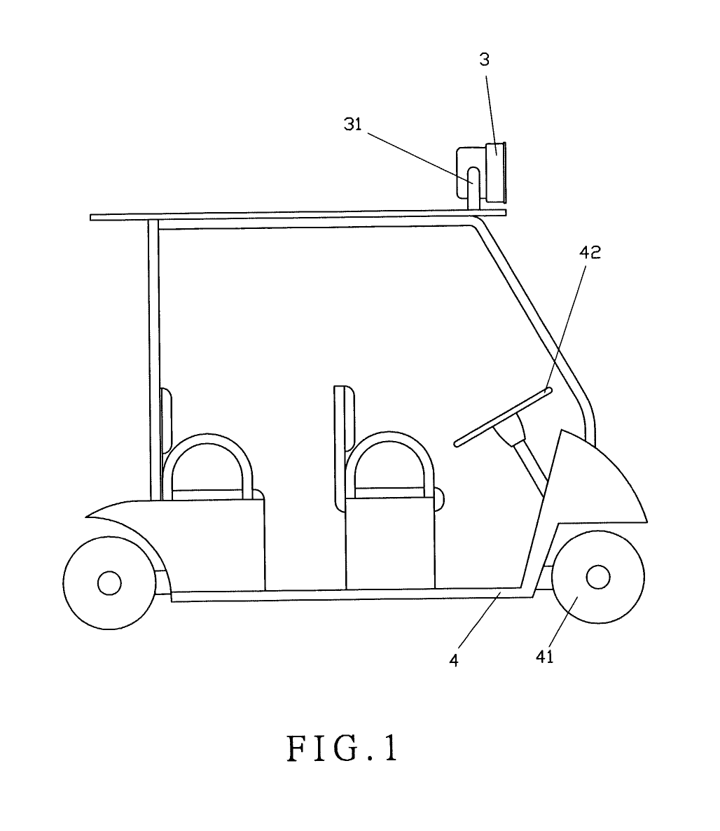

FIG. 2 is a front view of the illumination system of the present invention;

FIG. 3 is a side view showing a first embodiment of the angle adjusting mechanism of the lamp set;

FIG. 4 is a side view showing a second embodiment of the angle adjusting mechanism of the lamp set;

FIG. 5 is a side view showing a third embodiment of the angle adjusting mechanism of the lamp set; and

FIG. 6 is a side view showing a forth embodiment of the angle adjusting mechanism of the lamp set.

### DETAILED DESCRIPTION OF THE PREFERRED EMBODIMENTS

The mobile illumination system for a golf course of the present invention comprises a lamp set 3 secured on a vehicle 4 by at least one supporting mechanism 31.

The vehicle 4 comprises wheels 41 for moving around and a steering wheel 42 to control direction of movement, and the power to drive the vehicle may be regular battery or solar power.

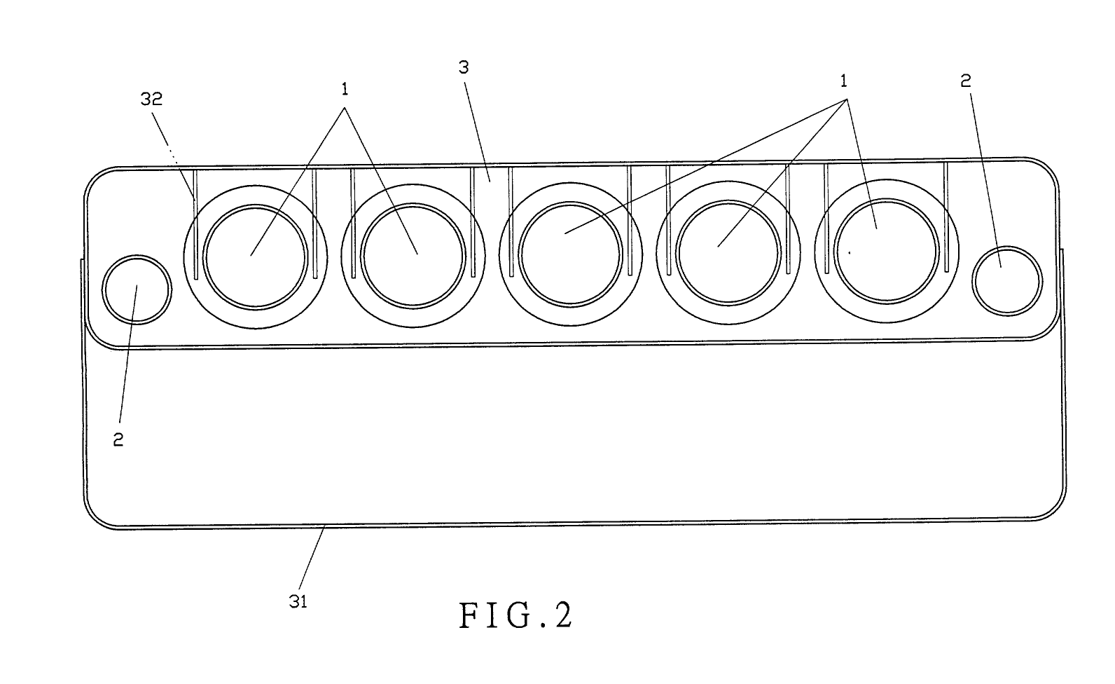

The lamp set 3, as shown in FIG. 2, comprises a plurality of spot lights 1 which are secured in the supporting mechanism 31 by a plurality of suspensions 32, and a pair of small lamps 2 secured at the respective sides of the supporting mechanism 31 to light up the front of the vehicle 4 for driving purpose. The lamp set 3 uses an angle adjusting mechanism, such as a linking set or a gear set, to drive the spot lights 1 and to adjust the angle of the spot lights 1. The lamp set 3 also can be driven directly by the angle adjusting mechanism to change the angle of the spot lights 1.

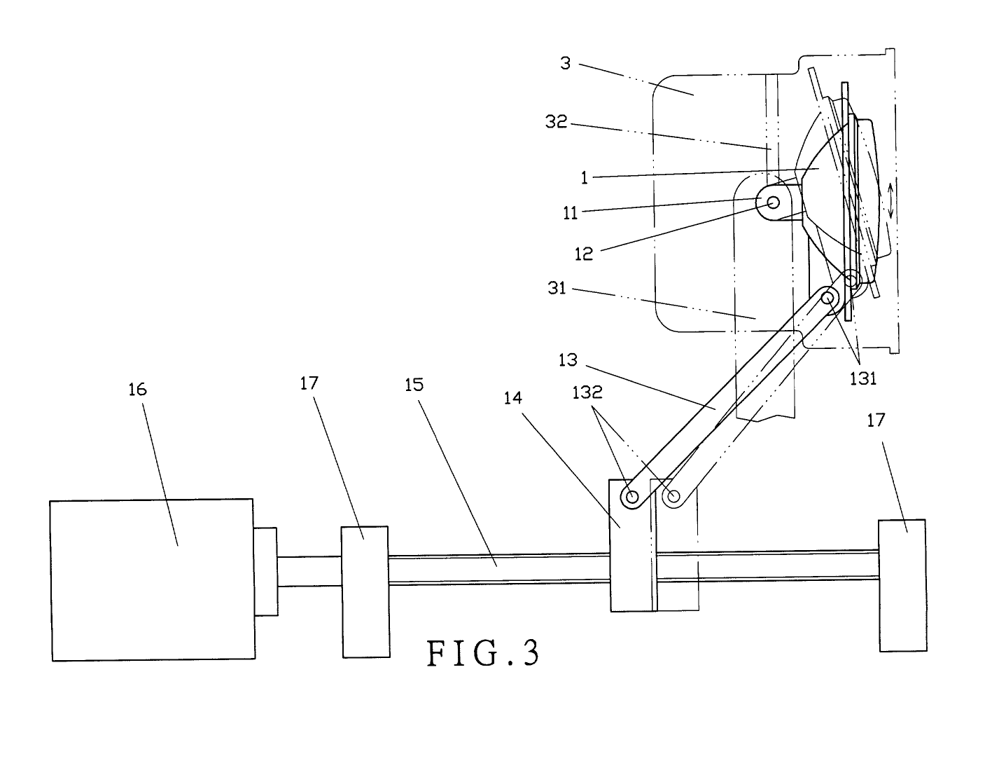

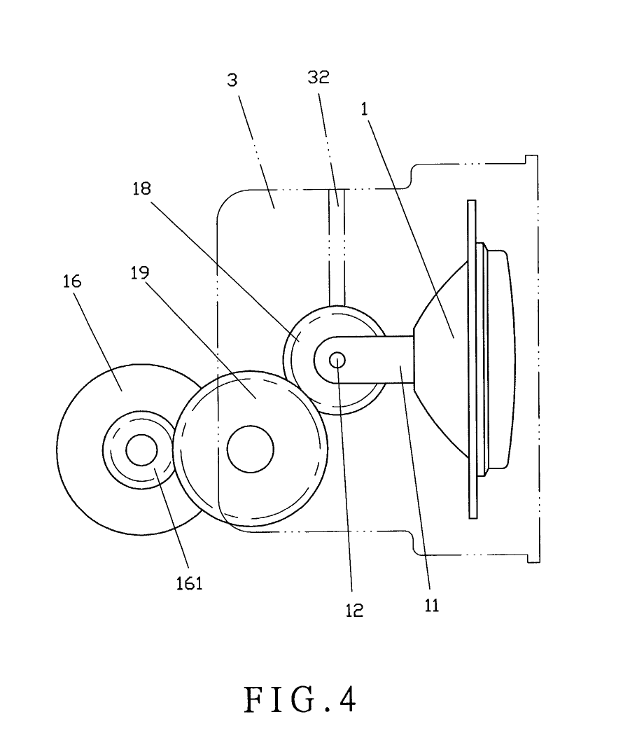

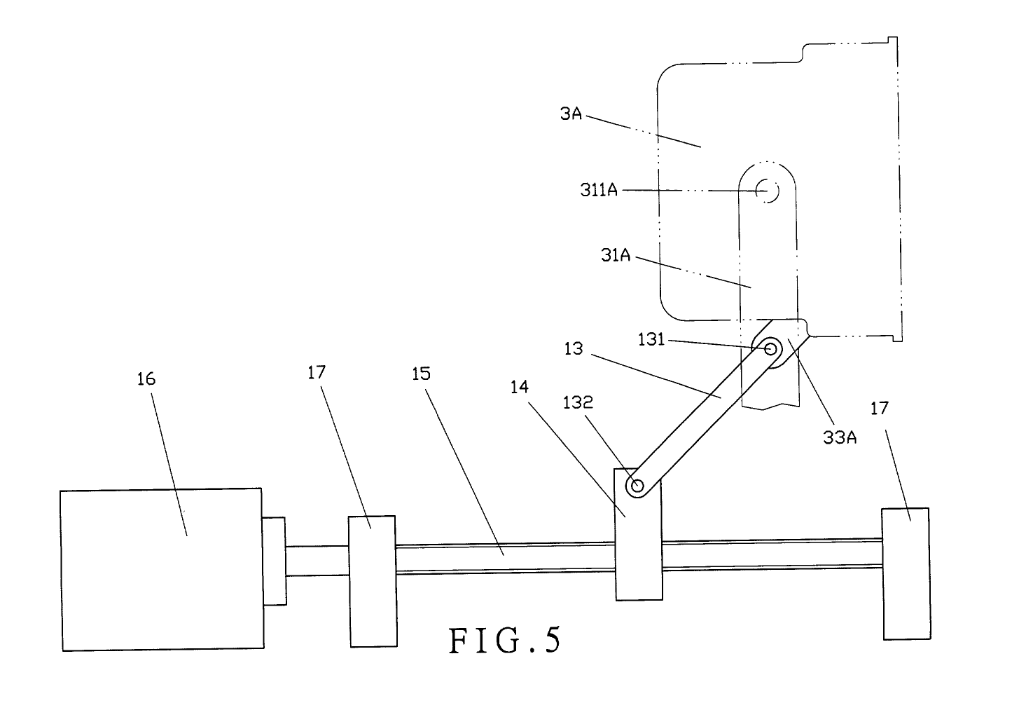

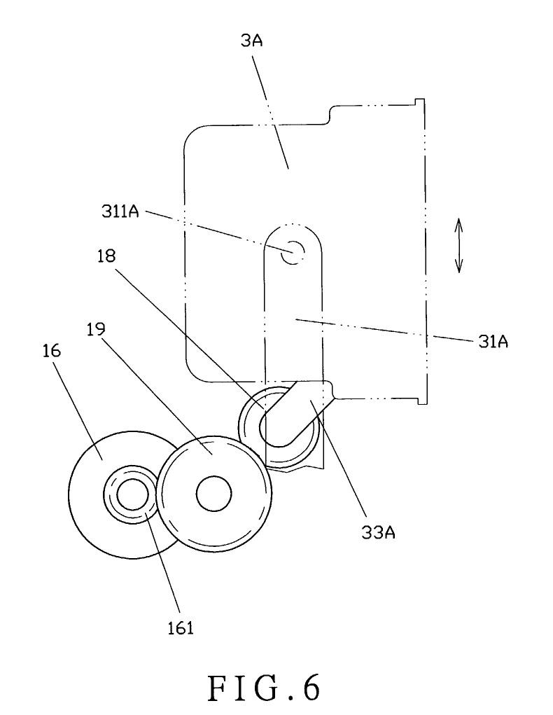

FIGS. 3 through 6 illustrates various embodiments of the angle adjusting mechanisms. As shown in FIG. 3, the lamp set 3 drives the spot lights 1 with a linking set. As shown in FIG. 4, the lamp set 3 drives the spot lights 3 with a gear set. As shown in FIG. 5, a linking rod directly drives the lamp set 3 to change the angle of the spot lights 1. As shown in FIG. 6, a gear set directly drives the lamp set 3 to change the angel of the spot lights 1.

As shown in FIG. 3, a linking set is adapted to operate the spot lights 1. The lamp set 3 comprises the supporting mechanism 31 with the suspensions 32 therein. Each of the spot lights 1 comprises a pair of lugs 11 protruding from the rear end with a shaft 12 connected to the suspension 32, whereat the linking set comprises a linking rod 13, a sliding block 14, a threaded rod 15, a motor 16 and a sleeve 17. The bottom end of the spot light 1 is connected to one end of the linking rod 13 through a shaft 131, while the other end of the linking rod 13 is pivoted to the sliding block 14 through another shaft 132. The sliding block 14 is threaded to the threaded rod 15, which then pivoted to the sleeve 17 driven by the motor 16. Thus, by moving the sliding rod 14 along the threaded rod 15, the spot light 1 is controlled to move forward or rearward and to adjust the angle of the spot lights 1.

FIG. 4 shows another embodiment of the angle adjusting mechanism, which uses a gear set to control the spot lights 1, wherein the lamp set 3 comprises the supporting mechanism 31 with the suspensions 32 therein, each of the spot lights 1 has a pair of lugs 11 protruding from the rear end of the spot light 1 with a shaft 12 connected to the suspension 32. The gear set comprises a motor 16 linking with a driving gear 161, a first driven gear 19 and a second driven gear 18, wherein the driving gear 161 meshes with the first driven gear 19, which in turn meshes with the second gear 18, which then fixed to the lugs 11, so that the motor 16 drives the lugs 11 to control the angle of the spot lights 1.

Another embodiment, as shown in FIG. 5, uses a linking set to drive the lamp set 3A directly and to change the angle of the spot lights 1. The lamp set 3A uses a shaft 311A to secure itself to the supporting mechanism 31A, and the bottom end of the lamp set 3A protrudes a pair of lugs 33A. The linking set includes a linking rod 13, a sliding block 14, a threaded rod 15, a motor 16 and a sleeve 17. The lugs 33A of the lamp set 3A are pivoted to one end of the linking rod 13 by a shaft 311A, and the other end of the linking rod 13 is pivoted to the sliding block 14 by another shaft 132, the sliding block 14 is threaded to the threaded rod 15, which then pivoted to the sleeve 17 driven by the motor 16. Thus, by moving the sliding rod 14 along the threaded rod 15, the lamp set 33A is controlled to move forward or rearward and to adjust the angle of the spot lights 1.

FIG. 6 shows a further embodiment of the angle adjusting mechanism that uses a gear set to control the lamp set 3A directly. The lamp set 3A is pivoted to the supporting mechanism 31A through a shaft 311A, and the bottom end of the lamp set 3A protrudes a pair of lugs 33A. The gear set includes a motor 16 which links with a driving gear 161, a first driven gear 19 and a second driven gear 18 in sequence, the second driven gear 18 is fixed to the lugs 33A. When the motor 16 is running, the lugs 11 are linked to move and further to adjust the angle of the spot lights 1.

I claim:

1. A mobile illustration system for a golf course comprising a lamp set and a vehicle, wherein:
said vehicle comprising wheels and a steering wheel;
said lamp set being secured on said vehicle by at least one supporting mechanism and comprising a plurality of spot lights connected to suspensions and an angle adjusting mechanism being able to adjust the angle of said lamp set;
by movement of said vehicle and said steering wheel to adjust the angle of said lamp set.

2. The mobile illustration system for a golf course, as recited in claim 1, wherein said angle adjusting mechanism is formed with a linking set to drive said spot lights of said lamp set, wherein each of said spot lights comprising a pair of lugs protruding from the rear end of said spot light and secured to said relative suspension by a shaft, said linking set comprising a linking rod, a sliding block, a threaded rod, a motor and a sleeve, wherein the bottom of said spot light providing a shaft pivoted to one end of said linking rod, while the other end of said linking rod being pivoted to said sliding block by another shaft, said sliding block being threaded to said threaded rod, which then pivoted to said sleeve and being driven by said motor, thus, by moving said sliding rod along said threaded rod, said spot lights being controlled to move forward or rearward and to adjust the angle of said spot lights.

3. The mobile illustration system for a golf course, as recited in claim 1, wherein said angle adjusting mechanism is formed with a gear set to drive said spot lights of said lamp set, each of said spot lights having a pair of lugs protruding from the rear end of said spot light and secured to said relative suspension by a shaft, wherein said gear set comprising a motor, a driving gear meshing with a first driven gear, which then meshing with a second driven gear, and which fixed to said lugs, thus said lugs being driven by said motor to change its angle.

4. The mobile illustration system for a golf course, as recited in claim 2, wherein said lamp set is secured to said supporting mechanism by a shaft, and said lamp set protrudes a pair of lugs from the bottom, said angle adjusting mechanism is formed with a linking set to drive said lamp set, said lugs being pivoted to one end of said linking rod, whereby said sliding block sliding along said threaded rod to adjust the angle of said lamp set with said spot lights.

5. The mobile illustration system for a golf course, as recited in claim 3, said lamp set is secured to said supporting mechanism by a shaft, and said lamp set protrudes a pair of lugs from the bottom, said angle adjusting mechanism is formed with a gear set to drive said lamp set, said gear set being adapt to adjust the angle of said lamp set, wherein said lugs of said lamp set being fixed with a second driven gear of said gear set, thus by sliding said sliding block along said threaded rod forward and rearward to adjust the angle of said lamp set with said spot lights.
